(19) United States
(12) Patent Application Publication
(10) Pub. No.: US 2009/0052972 A1
(43) Pub. Date: Feb. 26, 2009

(54) Cartridge used to dispense fluid within a brush

(76) Inventor: Michael DellaCorte, Floral Park, NY (US)

Correspondence Address: Russ Weinzimmer, 614 Nashua St. #204, Milford, NH, 03055, US

(21) Appl. No.: 11/895,693

(22) Filed: Aug. 25, 2007

(51) Int. Cl. A46B 11/00; B23P 19/04; B67D 5/64; B43K 5/06

(52) U.S. Cl. 401/179; 222/325; 29/700; 401/176

(57) ABSTRACT

A cartridge (10) for dispensing a single dose premeasured liquid, gel, cream or paste to a brush head (4). The cartridge (10) includes a cylindrical body (12) and tapered nozzle (18). The cartridge (10) is placed within a cavity (55) in a brush handle (52). A shaft (44) within the brush handle is advanced toward the brush head (4), causing a plunger (43) to abut a movable seal or end wall (2) of the cartridge (10). As the plunger (43) advances toward the head (4), the flowable contents (14) of the cartridge (10) are emptied and delivered to through a series of orifices (7) to the brush bristles (5, 6).

### FIELD OF THE INVENTION

The present invention relates generally to the field of fluid containers, and more particularly to a single use cartridge storing fluid that is dispensed to brush bristles.

### BACKGROUND OF THE INVENTION

Various portable or self contained toothbrushes exist, an example being disclosed in U.S. Pat. No. 776,468 entitled “FOUNTAIN TOOTH BRUSH”, issued to Hosmer on Nov. 29, 1904. A feature of such brushes a means to store a quantity of toothpaste somewhere within the brush structure. When the storage means is a reservoir, such as disclosed by Hosmer, an immediate problem is created by the need to fill and refill the reservoir. The filling operation requires skill and typically results in the loss of some of the filling material as the material source is mated to and detached from the reservoir.

Attempts have been made to eliminate the need for the reservoir refilling operation by placing a disposable container within the brush structure. For example, U.S. Pat. No. 1,859,402, entitled “RESERVOIR BRUSH”, issued to Maher on May 24, 1932, discloses a toothbrush having a handle in which an entire tube of toothpaste is stored. A user of the Maher device squeezes the toothpaste tube by gripping the brush handle. While the Maher device relieves the user of the burden of refilling the reservoir, the problem of accurate dispensing of toothpaste onto the brush bristles is not addressed.

Another toothpaste dispensing system is disclosed in U.S. Pat. No. 5,559,126, entitled “DISPOSABLE TOOTHBRUSH”, issued to Hough on Feb. 4, 1997. In the Hough device, a quantity of toothpaste is stored in the toothbrush handle. A pull tab covers an orifice in the brush head at the time of use. The brush handle is partially formed of a resilient membrane, so that as the brush handle is compressed the toothpaste exits the handle and exits through the orifice within the brush head. While the pull tab construction forces the toothbrush to indeed be limited to a single use, the reservoir contains an excessive amount of toothpaste and the membrane structure provides inadequate protection to the toothpaste reservoir from puncture and contamination.

A similar device is disclosed in U.S. Pat. No. 6,039,489, entitled “PASTE DISPENSING BRUSH”, issued to Harman et al. on Mar. 21, 2000. The Harmon device utilizes a cartridge instead of a toothpaste reservoir. The cartridge provides relatively better protection to the material within the cartridge, but the cartridge is large, containing toothpaste far in excess of a minimum effective amount. The Harmon device therefore requires a complex pumping and sealing arrangement to permit sanitary and effective use of the cartridge over an extended period of time.

None of the aforementioned devices discloses a fluid dispensing cartridge which contains an amount of fluid suitable for a single application. While such imprecision is tolerable for dispensing toothpaste, the aforementioned dispensing systems are unacceptable where the material being dispensed is a prescription drug that affects the safety and well being of the user. What is needed is a single use cartridge based dispensing system which provides automated dispensing of the entire contents of the cartridge to the bristles of a brush without requiring judgment or skill on the part of the user.

### SUMMARY OF THE INVENTION

The present invention is a single use cartridge that is housed within a brush and which dispenses the contents of the cartridge onto or near the bristles of the brush. The contents of the cartridge may be a paste, cream, gel or other relatively high viscosity, flowable material. The cartridge may contain, for example, a consumer item such as toothpaste, hair cream or nonprescription antibiotics, or the cartridge may contain a prescription medication intended for application to the skin, nails, teeth or hair. In all cases the cartridge contains a precisely measured amount of a flowable material that is dispensed substantially in its entirety when the punctured or opened cartridge is pressed or squeezed.

In a preferred embodiment of the invention a single premeasured cartridge is loaded into a storage and dispensing chamber within the brush body. The cartridge may be loaded into the brush via an access port in the brush handle or brush head. When application of the material within the cartridge is desired a plunger is advanced so as to squeeze or press a portion of the cartridge. The plunger advances throughout the original volume of the cartridge, forcing the contents of the cartridge through one or more orifices, seams, nozzles or other openings formed within the surface of the cartridge. The plunger head or piston tends to completely fill the original cartridge volume so that substantially all of the flowable material originally contained within the cartridge must necessarily exit the cartridge.

### BRIEF DESCRIPTION OF THE DRAWINGS

FIG. 1 is a perspective view of a fluid storage cartridge constructed according to the principles of the present invention;

FIG. 2 is a top plan view of the fluid storage cartridge depicted in FIG. 1;

FIG. 3 is a cross sectional view taken along line 3-3 in FIG. 2;

FIG. 4 is a perspective view of a of a brush assembly adapted to utilize the fluid storage cartridge depicted in FIG. 1; and

FIG. 5 is a perspective view of the brush assembly depicted in FIG. 4 with a fluid storage cartridge inserted into the brush assembly and utilizing an alternate embodiment of the cartridge.

### DETAILED DESCRIPTION OF THE INVENTION

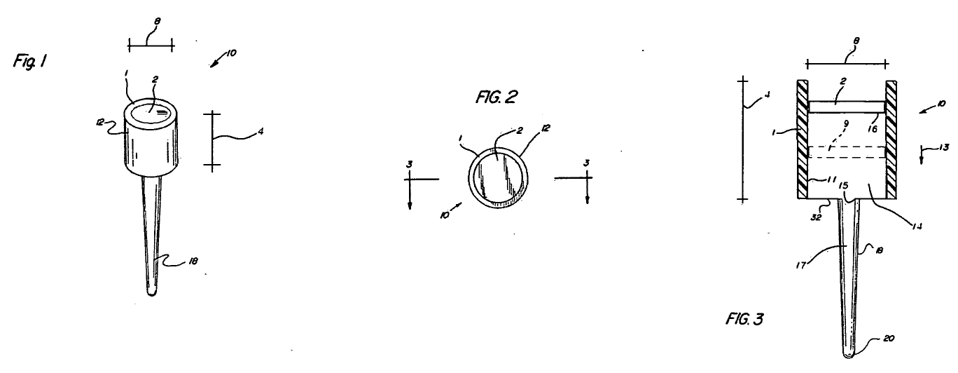

As seen in FIGS. 1 and 2, the flowable material or fluid storage cartridge 10 of the present invention is formed to have a generally cylindrical body 12. The body 12 may be formed of any relatively inert structural material such as plastic or paper board. In come cases the body 12 may be formed of a transparent or translucent material to permit a visual inspection as to the quantity and cleanliness of the cartridge contents. The cylindrical body 12 is formed of a substantially continuous wall 1 having a thickness sufficient to impart rigidity to the cartridge 10. The contents of the cartridge 1 may be any flowable material including but not limited to toothpaste, prescription medications, cleanser, nonprescription medications, antibiotics, an anti-inflammatory and a prescription strength tooth whitening agent. The wall 1 has a thickness which creates an inside diameter 8 of the cylindrical body 12, which together with the height 4 of the body 12 defines an interior volume of the cartridge 10.

The thickness of wall 1 and the height 4 of the cylindrical body 12 vary for each type and desired dosage of material that is placed within the cartridge 12 in order to define a single use, single dose disposable cartridge that, when emptied, has delivered a safe and effective quantity of flowable material. In other words, the cartridge 10 is manufactured to contain the precise single use quantity of the flowable substance housed within, and thus the dimensions of cartridge 10 will vary as needed for the material to be applied. In the case of a prescription medication, for example, a user of the cartridge 10 may receive from a dentist a series of ten cartridges, each containing a progressively smaller amount of the desired medication. Thus each successive cartridge 10 would have dimensions that were relatively smaller than the preceding cartridge. Each cartridge 10 would be labeled according to the order in which it was to be used.

The flowable material housed within the cartridge 10 may have the consistency of a gel, paste, liquid, cream, putty or slurry. The flowable material within the cartridge 10 is a substance generally intended for application to a part of the human body such as the teeth, skin, hair or nails.

The fluid material housed within the cartridge 10 is retained by means of a slidable seal, wall or plug 2. As best seen in FIG. 3, the slidable seal 2 is movable along the inner surface 11 of the wall 1. The seal 2 is movable in the direction of arrow 13, causing the seal to assume progressively displaced locations, such as the position shown for displaced seal 9, thereby urging the contents 14 of the cartridge 10 in the direction of lower wall 32. An orifice 15 is formed in the lower wall 32 which permits the flowable contents 14 of cartridge 10 to enter a nozzle 18. The nozzle 18 is preferably formed of plastic or other rigid, inert material and tapers to a tip 20. The tip 20 may in use be pierced by the device into which the cartridge 10 is inserted, or alternatively the tip 20 may be formed of a relatively thin membrane which splits or fails under the pressure of the advancing contents 14. In either case, the movement of the slidable seal 2 causes the contents to exit the nozzle 18. When the lower surface 16 of the advancing seal 2 reaches the lower wall 32, substantially all of the contents 14 will have exited the cartridge 14. The interior volume 17 of the nozzle 18 will retain some of the flowable contents 14, depending on the viscosity of the flowable material and any suction or wicking action generated by the device in which the cartridge 10 is placed. For each particular medication or treatment placed within the cartridge 10 an additional amount must be included in the cartridge to account for the flowable material retained within the volume 17 of the nozzle 18. Thus the diameter 8 and height 4 of the cartridge 10 must be increased to compensate for the volume 17 of flowable material 14 retained within the nozzle 18 so that the desired amount of flowable material reaches the brush bristles.

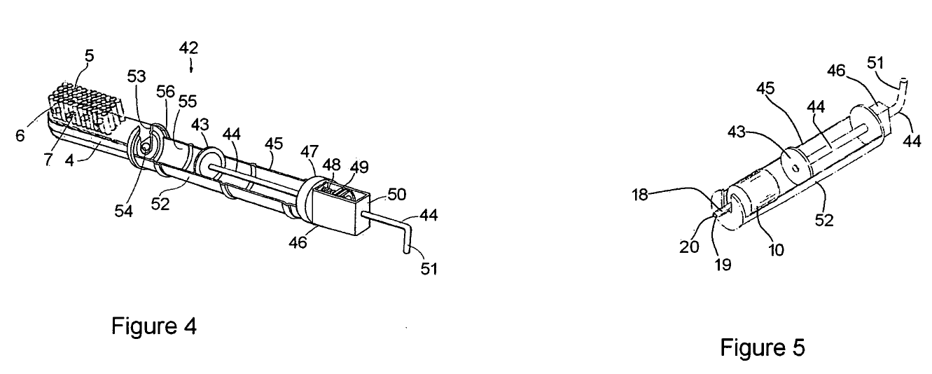

Referring also to FIGS. 4 and 5, the use of the cartridge 10 in an actual dispensing device 42 such as a toothbrush can be better appreciated. While a toothbrush is depicted for the purpose of explaining the use of the cartridge 10, any type of brush for any intended use may be similarly employed. The toothbrush handle 52 is seen to terminate at a head 4 which serves as a mounting platform for a plurality of bristles 5. The head 4 includes a series of orifices or perforations, such as orifices 6 and 7, for example, which are in fluid communication with the orifice 54 formed within the brush head 4. The orifices 6 and 7 are preferably of a diameter that is compatible with the expected viscosity of any fluid that may be expected to travel through them. Thus, a relative high viscosity material such as a paste would require relatively larger orifices, while a relative low viscosity material such as water would require a relatively smaller array of orifices approaching the characteristics of a perforated screen.

The cartridge 10 is mounted within the lidless cavity 55 formed within the brush handle 52 by the handle sidewalls 45. The cartridge 10 is retained in place by a lip 56 which includes a cutout region 53 that simplifies insertion of the cartridge 10 into the cavity 55. A plunger 43 abuts the end wall 59 of the cartridge 10 while a portion of the nozzle 18 extends through the orifice 54 formed within the brush head 4. A shaft 44 connects the plunger 43 to a user accessible handle 51. A housing 46 affixed to the rear bearing surface 47 of the brush handle 52 contains a spring 48 and grip 49 that together tend to retain the shaft 44 in whatever location the shaft currently occupies, the force of the grip being readily overcome by application of a longitudinal force to the shaft 44 via handle 51. As the contents 14 of the cartridge 10 are consumed the shaft 44 is advanced, causing the plunger 43 to apply pressure to the cartridge end wall or seal 2, thereby further urging the cartridge contents 14 through the orifice 54 and into the brush head 4.

In the embodiment illustrated in FIG. 5, the plunger 43 has a diameter greater than the diameter 8 of the cartridge 10. In this embodiment, the cartridge wall 12 is constructed of a material that is deformable. While wall 12 is initially rigid enough to safely house the contents 14 of the cartridge 10, the wall is made of a relatively deformable material such that the force applied by the plunger 43 is sufficient to crush or substantially flatten the cartridge 10. The tip 20 of nozzle 18 is constructed so as to include a frangible seam or membrane 19 that is substantially weaker than the wall 12, thereby ensuring that the flowable material will exit the tip 20 without causing a split or puncture of the wall 12. This embodiment of the cartridge 10 is advantageous insofar as the diameter of the plunger 43 need not be critically dimensioned to accommodate the diameter of the slidable seal 2.

While certain forms of the cartridge 10 have been illustrated, the invention is not limited to the specific arrangement of the components and the specific function of the steps as described and shown. Various changes may be made by those skilled in this field to the specific embodiments as described without departing from the scope of the invention. In particular, the method of advancing the plunger 44 may employ many alternative schemes while still utilizing the concept of applying a premeasured single use, single dose flowable material to a brush bristle 5. Further, the cartridge 10 may be located directly within the brush head 4 if the dimensions of the brush are sufficient to accommodate the cartridge. While the cavity 55 as disclosed is lidless, a lid or other closure may be provided. Similarly, the shape of the cartridge 10 may be modified so as to fill only a portion of the cavity 55, or the cartridge 10 may be composed of several discrete packages that are loaded into the cavity 55 simultaneously in order to achieve the desired single dose quantity. Further, the nozzle 18 of the cartridge 10 may be formed of a material that is relatively completely collapsible in response to a force applied in the direction of arrow 13, thereby permitting the flowable material 14 to be relatively completely emptied from the cartridge 10 without the need to add an initial additional amount of flowable material to the cartridge 10 in order to compensate for material retained in the interior volume 17 of the cartridge. The scope of the invention is defined by the claims.

What is claimed is:

1. A cartridge for dispensing a precise quantity of a flowable material to brush bristles, comprising:
a wall;
a slidable seal formed adjacent to the wall;
a nozzle, the nozzle being in fluid communication with an interior region substantially surrounded by the wall; and
an orifice, the orifice being formed within the nozzle so as to permit the flowable material to exit the cartridge.

2. The cartridge according to claim 1 wherein the flowable material is at least one of:
(a) a liquid;
(b) a paste;
(c) a cream;
(d) a gel; and
(e) a putty.

3. The cartridge according to claim 2 wherein the nozzle further comprises a frangible seam, the frangible seam residing near a tip region of the nozzle.

4. A cartridge according to claim 3 wherein the cartridge contains a single use amount of a prescription medication.

5. A cartridge according to claim 2 wherein the nozzle further comprises a membrane residing near the tip region of the nozzle.

6. A cartridge according to claim 3, wherein the cartridge contains less than a single use amount of a prescription medication, thereby requiring use of a plurality of cartridges in order to obtain a single use amount.

7. A cartridge according to claim 2, wherein the cartridge has a length, the slidable seal being adapted for translation along substantially all of the length of the cartridge.

8. A cartridge according to claim 7 wherein the nozzle contains an interior volume and at least some of the flowable material residing within the interior volume is not dispensable.

9. A cartridge according to claim 8 wherein a quantity of flowable material within the cartridge is in excess of a single use quantity by an amount equal to the interior volume of the nozzle.

10. A cartridge according to claim 9 wherein the wall of the cartridge is formed or a relatively rigid plastic material.

11. A cartridge according to claim 9 wherein the wall of the cartridge is formed of a relatively deformable material.

12. A cartridge according to claim 9 wherein the wall of the cartridge is formed of a paper material.

13. A cartridge according to claim 9 wherein the wall of the cartridge is formed of a relatively inert material.

14. A cartridge usable in a device adapted to deliver no more than a single use quantity of a medication to brush bristles, comprising:
(a) a substantially continuous, cylindrical sidewall that defines an interior region of the cartridge in which the medication resides;
(b) an end wall, the end wall forming a substantially fluid tight seal with the sidewall;
(c) a slidable seal, the seal forming a substantially fluid tight seal with the side wall; and
(d) a nozzle, the nozzle being rigidly affixed to the end wall, the nozzle being in fluid communication with the interior region of the cartridge.

15. The cartridge of claim 14, further comprising a frangible seam, the frangible seam being formed within the nozzle, the frangible seam being so constructed so as to fail in response to a relatively lower pressure than any other component of the cartridge.

16. The cartridge of claim 14, further comprising an orifice, the orifice being formed within a tip region of the nozzle.

17. A cartridge according to claim 16 wherein the slidable seal is adapted for translational motion throughout substantially an entirety of the interior region of the cartridge.

18. A cartridge according to claim 17 wherein the slidable seal is adapted to be abutted by a plunger in a device dispensing the flowable material to the brush bristles.

19. A cartridge according to claim 14 wherein the nozzle is substantially completely collapsible in response to an external longitudinal force.

20. A method of forming a cartridge adapted to dispense a precise, and no greater than a single use amount of a prescription flowable medication onto a plurality of brush bristles mounted on a brush head, comprising the activities of:
(a) forming a cylinder of a material having sufficient strength to safely retain the flowable material;
(b) forming a nozzle so as to be in fluid communication with the flowable material retained within the cylinder; and
(c) forming a slidable seal capable of translational movement within the cylinder, the slidable seal being adapted to move from a first position where the cylinder contains all of the prescription flowable material to a second position where the cylinder contains none of the prescription flowable material.
